(19) United States
(12) Patent Application Publication
(10) Pub. No.: US 2006/0036542 A1
(43) Pub. Date: Feb. 16, 2006

(54) System and method for behavioral finance

(76) Inventor: Douglas S. McNair, Gloucester, MA (US)

Correspondence Address: BLANK ROME LLP, 600 NEW HAMPSHIRE AVENUE, N.W., WASHINGTON, DC, 20037, US

(21) Appl. No.: 11/176,940

(22) Filed: Jul. 8, 2005

Related U.S. Application Data
(60) Provisional application No. 60/586,410, filed on Jul. 9, 2004.

(51) Int. Cl. G06Q 40/00

(52) U.S. Cl. 705/39

(57) ABSTRACT

A system suitable for an automated investment share price pattern search includes a computer, a historical information database accessible by the computer having historical information for a plurality of investments stored thereon, a connection to a supply of real-time or historical timeseries data, the data comprising real-time or historical data relating to a plurality of investments. Software executing on the computer generates an investment classification for the investment to be examined based upon the historical information and the real-time data relating to the investment or investments to be examined. The process gathers price and volume data of listed firms from arbitrarily many stock markets. The invention uses the statistics of asymmetric stochastic volatility (ASV) to classify and associate the recent fluctuations in share price with a recommended action: sell, buy, or hold.

### REFERENCE TO RELATED APPLICATION

The present application claims the benefit of U.S. Provisional Patent Application No. 60/586,410, filed Jul. 9, 2004, whose disclosure is hereby incorporated by reference in its entirety into the present disclosure.

### FIELD OF THE INVENTION

The present invention relates generally to technical analysis. More particularly, the present invention relates to a method of timeseries markup and annotation in technical analysis of stock investments and an automated system for assisting investors in deciding whether to buy or sell certain investments, and more particularly to such a system which automatically analyzes investment timeseries patterns to determine whether certain buy or sell indicators are present.

### BACKGROUND OF THE INVENTION

Technical financial analysis, as opposed to fundamental analysis, uses the timeseries of prices of historical trades, the timeseries of trading volumes, or other measures of a stock, or of a market as a whole, to predict the future direction of the stock or market and to identify turning points, trends, or other information. Recognizing patterns in the timeseries is greatly enhanced by efficient pattern recognition and automated signaling or annotation of the timeseries.

Many traders utilize trading strategies and make decisions based on technical analysis. Their strategies hold that publicly available technical data of an investment—such as the open, high, low, and close prices, daily volumes, trade price and size, and bid/ask prices and bid/ask sizes—contain information that can predict the future price movements of the investment and that analyzing such timeseries data can enable them to achieve superior returns on their investment decisions.

Over the course of the past 70 years, technical analysts have developed a wide variety of indicators based on timeseries data for stocks. For example, moving averages (MA), relative strength indexes (RSI), moving average convergence and divergence (MACD), Bollinger bands, K/D stochastic analysis, and various indexes are among the popular calculated indicators used to characterize individual stocks. Technical analysts and traders believe that certain investment indicator patterns provide early signals of buy and sell opportunities. Today computers are routinely used to plot investment timeseries with share prices and volumes and various calculated indicators, and the indicator signals and annotations pertaining to the investments plotted are used by the traders to implement a trading strategy.

Technical trading can only succeed in the long run if it is possible to accurately identify buy or sell patterns from the timeseries data, and to detect them early enough so that the appropriate trades can be undertaken. Finding a pattern after the trading opportunity has passed and is no longer valid has no utility at all. Finding a pattern late—after other traders in the market have recognized it and reacted to it, or so late in the context of the stock's daily market volume and liquidity such that it is impossible to find counterparties to execute trades in the size necessary to achieve one's desired position in the stock—also has little value.

A number of terms of art are used in the present specification. An indicator is a calculation based on stock price and/or volume that produces a number in the same unit as price. An example of an indicator is the moving average of a stock price. An oscillator is a calculation based on stock price and/or volume that produces a number within a range. An example of an oscillator is the moving average convergence/divergence (MACD).

The terms “technical event” and “fundamental event” are terms denoting points such as the price crossing the moving average or the MACD crossing the zero-line. A technical event or fundamental event occurs at a specific point in time. Trading signals associated with most indicators and most oscillators can be represented as technical events. A technical event, as used herein, is the point in time where a share price has interacted with an indicator or a price pattern or an oscillator has crossed a threshold. Fundamental events are the point in time where a share price has interacted with a price value computed from company accounting data, from data pertaining to the valuation of the company's assets and liabilities and financial leverage, and/or other economic data.

A price pattern is a classification of a timeseries segment that indicates changes in the supply and demand for a stock, which is associated with a significant rise or fall in share price. A reversal pattern is a type of price pattern that indicates a change in the direction of a price trend. If prices are trending down, then a reversal pattern is bullish, since its appearance is believed to indicate prices will move higher. Conversely, if prices are trending up, then a reversal pattern will be bearish. Price patterns have been described by a number of authors, including Edwards and Magee.

Price patterns that predict or denote latent fundamental events are particularly valuable to traders. Stochastic volatility (SV) models infer changes in a company's financial leverage that have not yet materialized but are nonetheless revealed by subtle shifts in investor sentiment affecting trades by certain insiders and analysts who have close and recent knowledge of the company's situation, reflected in share price timeseries data.

Two alternative SV specifications co-exist in the literature. One is the conventional Euler approximation to the continuous-time SV model with leverage effect. The other is the discrete-time SV model of Jacquier. Using a Gaussian nonlinear state space form with uncorrelated measurement and jump transition errors, it is possible to interpret the leverage effect in the conventional model. The SP500, Russell3000, and other portfolios of highly liquid stocks show strong evidence of the expected leverage effect. However, thinly-traded small- and mid-cap stocks show only a small leverage effect or, in some cases, paradoxical inverse leverage. The natural log of the period-to-period ratio of the estimated stochastic volatility σᵥ appears to be a robust leading indicator of emergent investor sentiment with regard to structural issues that affect a particular firm or sector.

In sectors represented by firms with single product lines that are still in development (pre-commercialization), such as biotech and early-stage pharma/biopharma companies, there tends to be scanty information regarding factors that predict the future approval, market penetration, and growth of the firms. Newly emerging information concerning a class of therapeutic compounds, such as convincing efficacy results or clearer understanding of the mechanism of action, can lead to a groundswell of positive opinion regarding the future of the entire class of compounds. Likewise, in highly-regulated sectors such as healthcare services, the outcome of anticipated regulation or coverages and reimbursement decisions is highly uncertain, and accurate information that bears on the likelihood of various outcomes is not regularly or frequently accessible to the majority of investors. However, once the consideration of certain evidence by the AHRQ-CMS MCAC committee becomes known, prevailing opinion rapidly converges toward the most probable regulatory decision.

Insofar as the equities of such firms show excess volatility (noise) compared to firms of similar size in industries that are not subject to as much uncertainty, finding a reliable signal of emerging investor sentiment is difficult. In this connection, stochastic volatility (SV) models have gained much attention both in the option pricing literature and financial econometrics literature (Andersen (1999), Engle (1993), Fouque (2000), Harvey (1996), Hull & White (1987); see Shephard (1996) for a review of SV models and their applications).

The relationship between volatility and price/return has long been a subject of study. Conventional wisdom holds that when there is bad news (which decreases the price and indirectly increases a credit's debt-to-equity ratio, i.e., financial leverage), the credit becomes riskier. The event tends to be associated with an increase in future expected volatility of the credit's common shares. A premium is attached to the implied future expected volatility and this is reflected in short-term share price. As a result, the leverage effect must correspond to a negative correlation between volatility and price/return. Christie (1982) found empirical evidence of such a leverage effect. By computing volatility from end-of-day data, Christie postulated a parametric form for the volatility—return relationship, enabling a simple test for leverage effect.

In the option pricing literature, the asymmetric SV model (ASV) is often formulated in terms of stochastic differential equations. One widely-used ASV model specifies the following equations for the logarithmic asset price s(t) and the corresponding volatility:

$$\{ \begin{matrix}ds ( t ) = σ ( t ) d {B}_{1} ( t ) , \\ d ln {σ}^{2} ( t ) = α + {βlnσ}^{2} ( t ) dt + {σ}_{υ} d {B}_{2} ( t ) ,\end{matrix} \qquad Eq .1$$

where B₁(t) and B₂(t) are two Brownian motions, corr(dB₁(t), dB₂(t))=ρ, and s(t)=ln(P(t)) with P(t) being the share price of the underlying. When ρ<0 we have the leverage effect.

In the empirical literature the above model is often discretized to facilitate estimation and to reflect the practical realities of the timeseries data that are available. The Euler-Maruyama approximation leads to our proposed discrete-time ASV model:

$$\{ \begin{matrix}{X}_{t} = {σ}_{t} {u}_{t} , \\ ln {σ}_{t + 1}^{2} = α + {ϕlnσ}_{t}^{2} + {σ}_{υ} , {v}_{t + 1} ,\end{matrix} \qquad Eq .2$$

where Xₜ=s(t+1)−s(t) is a continuously-compounded return, uₜ=B₁(t+1)−B₁(t), vₜ₊₁=B₂(t+1)−B₂(t), φ=1+β. Hence, uₜ and vₜ are iid N(0, 1) and corr(uₜ, vₜ₊₁)=ρ. This ASV model has been previously studied by a quasi maximum likelihood method in Harvey and Shephard (1996) and by MCMC in Meyer and Yu (2000).

To understand the linkage of the alternative ASV specifications to the leverage effect, it is convenient to adopt a Gaussian nonlinear state space form with uncorrelated measurement and transition equation errors. To do this, we use the identity wₜ₊₁=(vₜ₊₁−ρuₜ)/√(1−ρ²) and rewrite Eq. (2) as:

$$\{ \begin{matrix}{X}_{t} = {σ}_{t} {u}_{t} , \\ ln {σ}_{t + 1}^{2} = α + {ϕlnσ}_{t}^{2} + {ρσ}_{υ} , {σ}_{t}^{- 1} {X}_{t} + {σ}_{υ} \sqrt{1 - {ρ}^{2}} {w}_{t + 1} ,\end{matrix} \qquad Eq .3$$

where wₜ˜N(0, 1). This is a linear function in Xₜ which implies that, if ρ<0 and everything else is held constant, a fall in the stock price/return leads to an increase of E(ln σₜ₊₁²|Xₜ). This is intuitively consistent with the normal leverage effect we expect in an efficient market.

Similarly, for the Jacquier ASV in nonlinear Gaussian state space form we have:

$$\{ \begin{matrix}{X}_{t} = {σ}_{t} {u}_{t} , \\ ln {σ}_{t + 1}^{2} = α + {ϕlnσ}_{t}^{2} + {ρσ}_{υ} , {σ}_{t}^{- 1} {X}_{t + 1} + {σ}_{υ} \sqrt{1 - {ρ}^{2}} {w}_{t + 1} .\end{matrix} \qquad Eq .4$$

Because σₜ₊₁ appears on both sides of the equation, it is impossible to obtain the relationship between E(ln σₜ₊₁²|Xₜ) and Xₜ in analytical form. Therefore, it is not clear how to interpret the leverage effect in Jacquier's ASV model specification.

### REFERENCES

Andersen T, Chung H, Sorensen B. Efficient method of moments estimation of a stochastic volatility model: A Monte Carlo study. J Econometr 1999; 91:61-87.
Chib S, Nardari F, Shephard N. Markov Chain Monte Carlo methods and stochastic volatility models. J Econometr 2002; 108:281-316.
Christie A A. The stochastic behavior of common stock variances. J Fin Econ 1982; 10:407-32.
Edwards R D, Magee J. Technical Analysis of Stock Trends. St. Lucie Press, 1998.
Engle R, Ng V. Measuring and testing the impact of news in volatility. J Fin 1993; 43:1749-78.
Eraker B, Johannes M, Polson N. The impact of jumps in volatility and returns. J Fin 2003; 53:1269-300.
Fouque J-P, Papanicolaou G, Sircar K R. Derivatives in Financial Markets with Stochastic Volatility. Cambridge: Cambridge Univ Press, 2000.
Harvey A C, Shephard N. The estimation of an asymmetric stochastic volatility model for asset returns. J Bus Econ Stat 1996; 14:429-34.
Hull J, White A. The pricing of options on assets with stochastic volatilities. J Fin 1987; 42:281-300.
Jacquier E, N. G. Polson N G, Rossi P E. Bayesian analysis of stochastic volatility models. J Bus Econ Stat 1994; 12:371-89.
Kim S, Shephard N, Chib S. Stochastic volatility: Likelihood inference and comparison with ARCH models. Rev Econ Stud 1998; 65:361-93.
Kitagawa G. Monte Carlo filter and smoother for Gaussian nonlinear state space models. J Comput Graph Stat 1996; 5:1-25.
Meyer R, Yu J. BUGS for a Bayesian analysis of stochastic volatility models. Econometr J 2000; 3:198-215.
Rogers E M. Diffusion of Innovations. 5e. New York: Free Press, 2003.
Shephard N. “Statistical aspects of ARCH and stochastic volatility.” In Cox DR, Hinkley D V, Barndorff-Nielson O E. (eds), Time Series Models in Econometrics, Finance and Other Fields, pp. 1-67. London: Chapman & Hall, 1996.
Shleifer A. Inefficient Markets: Introduction to Behavioral Finance. Oxford: Oxford Univ Press, 2000.

### SUMMARY

What is desired, therefore, is an automated system for assisting investors in deciding whether to buy or sell investments which automatically analyzes investments to determine if leading buy or sell indicators are present; which is capable of identifying buy or sell indicators well in advance of a technical event or fundamental event so that they can be acted upon while they are still valid and trades can be executed in the sizes desired; and which automatically analyzes investment timeseries to take trading decisions about investments.

Accordingly, it is an object of the present invention to provide an automated system for assisting investors in deciding whether to buy or sell investments, which automatically analyzes investments to determine if buy or sell indicators are present.

A further object of the present invention is to provide a system having the above characteristics and which is capable of quickly identifying buy or sell indicators so that they can be acted upon while they are still valid and while there is time sufficient for the trader to adjust his or her positions in the stock before other traders in the market react or before publication of news related to the fundamental event predicted by the ASV indicator impairs the stock's liquidity.

These and other objects of the present invention are achieved by provision of an automated investment timeseries pattern search system, which includes a computer, a information database accessible by the computer having historical information for a plurality of investments stored thereon, a connection to a supply of real-time data, the data comprising real-time data relating to a plurality of investments, and a templates database accessible by the computer having a plurality of templates stored thereon. Software executing on the computer generates an investment chart for the stock or stocks to be examined based upon the historical information and the real-time data relating to the stock or stocks to be examined. Software executing on the computer then performs ASV analysis on the stock timeseries to determine if an ASV pattern exists in the timeseries. The present invention utilizes the asymmetric stochastic volatility timeseries to reliably predict investor sentiment trajectories.

In accordance with the invention, a method and system mitigating the limitations enumerated above and suitable for a stock investment signaling procedure is provided. It is an object of the present invention to mitigate at least one disadvantage of previous methods for technical analysis of stocks. It is a particular object of the present invention to provide a method for generating timeseries markup and directly annotating a timeseries based on categorized incipient fundamental and technical events and recognized patterns in timeseries of financial data, such as stock prices.

According to a first aspect, there is provided a method for generating markup classifications for annotating a chart of timeseries data. A volatility feature set of technical event data related to the timeseries data is stored in a database. The volatility feature set includes identification of ASV inflection points in the timeseries data, pattern recognition data derived from the identified ASV inflection points, the identified ASV inflection points and the timeseries data. The method comprises receiving, from a client, a request for markup information related to a stock or a plurality of stocks. Price and volume timeseries for the stock or stocks are downloaded, ASV calculations are performed, and features associated with the stock are then selected from the volatility feature set. Markup tags are then determined in accordance with the selected features, and the markup tags are assembled, in accordance with a markup format, to generate a markup annotation for the event. The markup annotation contains the requested markup information. The recommendation contained in the markup annotation is then sent to the client.

In a further embodiment, the method includes displaying the timeseries as a chart at the client location, and annotating the chart in accordance with the markup information. The method can also include analyzing and manipulating the markup information at the client. The client can also specify a desired format for the markup information in the initial request. Preferably, the markup information is initially provided as an XML block, and then transformed, if desired, into any other desired format, such as HTML. Typically the features are also selected in accordance with the request.

In a further aspect, the present invention provides a method for generating markup for annotating timeseries data having an associated volatility feature set as described above. The method comprises selecting features associated with an event from the volatility feature set; determining markup tags in accordance with the selected features; and assembling the markup tags, in accordance with a markup format, to generate a markup annotation for the event.

Preferably, software executing on the computer pre-screens the historical information and the real-time data relating to the investment to be examined to determine whether the investment to be examined meets a threshold value for liquidity, and the software executing on the computer performs the ASV analysis only if the investment to be examined meets the threshold value for liquidity. Preferably, the investment to be examined is determined to meet the threshold value for liquidity if both average daily trading volumes and average daily prices for the investment to be determined meet a threshold value. Most preferably, the investment to be examined is determined to meet the threshold value for liquidity if the current day's trading volume is higher than average daily trading volumes.

Preferably, the system also includes software executing on the computer for, if it is determined that a pattern exists in the stock timeseries, generating and transmitting to a user an indication that an actionable ASV pattern has been detected.

Following Meyer and Yu (2000), our proposed ASV model and Jacquier's ASV model can be written, respectively, as:

$$\begin{matrix}\begin{matrix}{h}_{t + 1} \vert {h}_{t} , α , ϕ , {σ}_{υ}^{2} ∼ N ( α + ϕ {h}_{t} , {σ}_{υ}^{2} ) , \\ {X}_{t} \vert {h}_{t + 1} , {h}_{t} , α , ϕ , {σ}_{υ}^{2} , ρ ∼ N ( \frac{ρ}{{σ}_{υ}} {ⅇ}^{{h}_{t} / 2} ( {h}_{t + 1} - α - ϕ {h}_{t} ) , {ⅇ}^{{h}_{t}} ( 1 - {ρ}^{2} ) ) ,\end{matrix} \\ and & Eq .5 \\ \begin{matrix}{h}_{t} \vert {h}_{t - 1} , α , {ϕ}_{t} , {σ}_{υ}^{2} ∼ N ( α + ϕ {h}_{t - 1} , {σ}_{υ}^{2} ) , \\ {X}_{t} \vert {h}_{t} , {h}_{t - 1} , α , ϕ , {σ}_{υ}^{2} , ρ ∼ N ( \frac{ρ}{{σ}_{υ}} {ⅇ}^{{h}_{t} / 2} ( {h}_{t} - α - ϕ {h}_{t - 1} ) , {ⅇ}^{{h}_{t}} ( 1 - {ρ}^{2} ) ) ,\end{matrix} & Eq .6\end{matrix}$$

where hₜ=ln σₜ². These representations permit straightforward Bayesian MCMC parameter estimation using BUGS (http://www.mrc-bsu.cam.ac.uk/bugs/winbugs/contents.shtml) software.

Regarding the prior distributions, for the parameters φ and σᵥ² the prior specifications of Kim, Shephard and Chib (1998) are effective in one embodiment: σᵥ²˜Inverse-Gamma (2.5, 0.025), which has a mean of 0.167 and a standard deviation of 0.024; φ*˜Beta (20, 1.5), which has a mean of 0.167 and a standard deviation of 0.86 and 0.11, where φ*=(φ+1)/2. Furthermore, following Meyer and Yu (2000) in one embodiment it is satisfactory to take μ˜N(0, 25), where μ=α/(1−φ). For the MCMC initialization, the leverage correlation parameter ρ is assumed to be uniformly distributed between −1 and 1 (perfect a priori ignorance of leverage effect distribution).

Other aspects and features of the present invention will become apparent to those ordinarily skilled in the art upon review of the following description of specific embodiments of the invention in conjunction with the accompanying figures.

### DESCRIPTION OF DRAWINGS

Embodiments of the present invention will now be described, by way of example only, with reference to the attached figures, wherein:

FIG. 1 is a block diagram of a computing system on which the preferred embodiment can be implemented;

FIG. 2 is a flow chart of the overall steps carried out in the preferred embodiment;

FIG. 3 is a block diagram of a system according to the preferred embodiment;

FIG. 4 is a timeseries chart annotated according to the preferred embodiment;

FIG. 5 is a timeseries chart annotated according to a sample XML markup annotation contained herein; and

FIG. 6 is a plot of data used for back-testing an example stock.

### DETAILED DESCRIPTION OF THE PREFERRED EMBODIMENT

A preferred embodiment of the present invention will be set forth in detail with reference to the drawings.

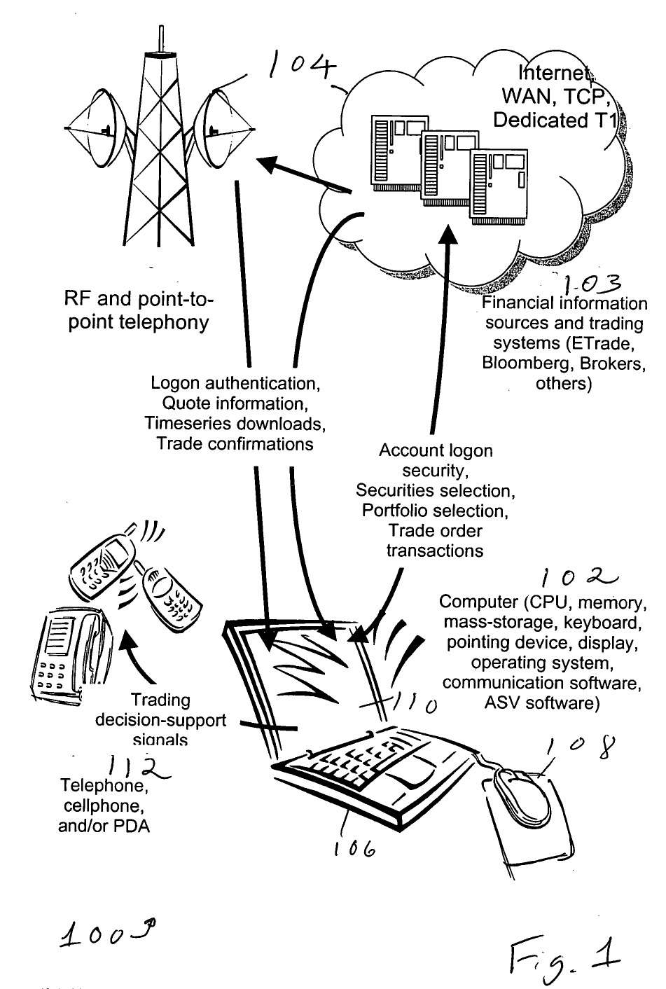

In the preferred embodiment as shown in FIG. 1, the system 100 is comprised of a computer 102, which, as is well-known to those skilled in the art is comprised, among other things, of a processor, memory and mass storage. The computer may also be networked to take advantage of other resources 103 on a local or wide area network or the Internet (collectively identified as 104). In addition, the computer 102 can interface with an investment trader through a keyboard 106, mouse 108, and display device 110. The computer 102 may take the form of remote or wireless devices that can perform computations or receive investment signals from other computers or system practicing the present invention and the display device can take the form of a remote device, such as a personal digital assistant, pager or cell-phone (collectively shown as 112) with a visual, audio or tactile capabilities to communicate the investment signals. The computer executes the steps described herein to practice the present invention, and a display device, which may be separate from the computer, presents the results to the investment trader.

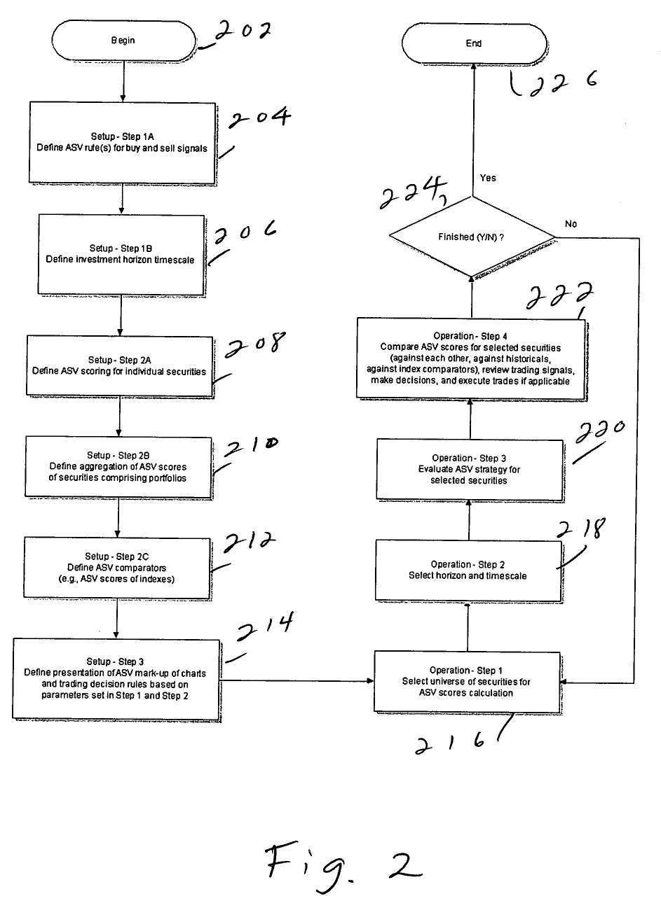

Alternative embodiments of the present invention may also include transmitters to send information to the investment trader to request information and receivers to receive information back from the investment trader in accordance with the present invention. Overall Steps (explained with reference to FIG. 2)

The following steps describe one aspect of practicing the present invention, beginning with step 202:

Step 204: Define the ASV rule that can be coded to produce from published information, a sequence of buy and sell signals for every security in a given universe. Further define, in step 206, a set of time-scales for investment horizons to which the rules for each strategy can be adapted in order to produce buy and sell signals for every security in a given universe over those time-scales.

In step 208, define a method of scoring the strategy's usefulness, for a time-scale, as applied to every security in a given investment universe, as well as scoring the aggregate usefulness of the strategy over all the securities in the given investment universe in step 210. Further define a method of presenting that information for each security, and of comparing that information among the securities in the given investment universe, in step 212.

In step 214, define a method of scoring every security in the given universe according to the buy and sell signals given by the ASV strategy for a time-scale, in conjunction with published information such as the security's price behavior. Further define a method of presenting that information for each security, and of comparing that information among the securities in the given investment universe.

With these definitions in place, the system will generate the following:
1. For all securities in the system, scores for the usefulness of the ASV strategy over every time-scale, as well as the aggregate scores for these categories.
2. For all securities in the system, scores for securities according to the ASV strategy over every time-scale.

With these definitions in place, users can proceed as follows:
1. Select a universe of securities (step 216).
2. Select a time-scale (step 218).
3. Compare between securities the ASV strategy's usefulness at that time-scale (step 220).
4. Compare between securities their scores given by the strategy (step 222).

When the user is finished, as determined in step 224, the process ends in step 226.

Setting Time-Scales, Measuring Performance Results

1. Steps will now be described in more detail:
i. The steps for applying an ASV investment strategy to a universe of securities to generate buy and sell signals for every security in the universe are as follows:
   a. Buy and Sell Signals

A buy signal is a signal to purchase the security. A buy signal remains in effect until it is reversed by a sell signal, so that as far as the strategy is concerned, a security with a buy signal is bought and held until the strategy steps emits a sell signal for the security. A sell signal is a signal to sell the security. A sell signal remains in effect until it is reversed by a buy signal, so that as far as the strategy is concerned, a security with a sell signal is sold and not held until the steps emits a buy signal for the security.

b. Frequency of Updates to the Buy and Sell Signals

The steps for a strategy can update buy and sell signals at any frequency. For instance, the steps for a strategy can be run to update the latest buy and sell signals for each security in the universe per day, per week and so on.

c. Time-Scales for the Buy and Sell Signals

Investment horizons vary according to individual investors. In order to provide buy and sell signals for groups of investors with shorter and longer investment horizons, the steps for a strategy generate separate sets of buy and sell signals for the securities in the universe according to shorter or longer time-scales.
1) A statistically meaningful sample size is needed to evaluate the performance of an ASV strategy's buy and sell signals according to the confidence interval for results that is required. Sample sizes less than 70 give confidence intervals that would be too large for many investors. This gives minimum time-scales of 70 days for daily signals, and 70 weeks for weekly signals, and so on.
2) The data measurements input for a strategy are adjusted to provide a sets of buy and sell signals for securities in the universe for each time-scale. The set of buy and sell signals that the strategy generates for each security in the universe by using data measurements designed to give signals for a minutely time-scale is called the set of minutely signals for the strategy. The set of buy and sell signals that the strategy generates for each security in the universe by using data measurements designed to give signals for a weekly time-scale is called the set of weekly signals for the strategy, and so on.
3) Because the data measurements used by the strategy are not the same for each time-scale, the sets of buy and sell signals generated by the strategy for shorter and longer time-scales are likely to differ.
   d. Sampling Intervals to Create Histories of Buy and Sell Signals Over a Period
1) For a given time-scale, the strategy generates buy and sell signals for each security in the universe. Histories of buy and sell signals are created by recording the signals at intervals over a period. The sampling intervals vary according to the time-scale for which the signals are generated. For example:
a) Daily. A set of daily signals is created by sampling the signals at the daily market close. If done for 120 days, this will create a history of daily buy and sell signals for the period with 120 data points for each security.
b) Weekly. A set of weekly signals is created by sampling the signals at the weekly market close. If done for 120 weeks, this will create a history of weekly buy and sell signals for the period with 120 data points for each security.
2) The interval at which signals for a time-scale are sampled in order to create histories of signals can be much longer than the frequency at which the signals are updated. For instance, although signals calculated for a daily time-scale can be updated each minute, it can be that only the signal at the daily close is taken into account for the history of the daily buy and sell signals.
3) The steps can be applied to historical data sets to generate histories of buy and sell signals as they would have appeared in the past. In this way, buy and sell signal histories of any length for any time-scale can be generated, covering any period for which there is data.
ii. Measuring the Performance Results. These steps will generate for every security in the universe the performance statistics that result from investing over a period according to the strategy's buy and sell signals at a given time-scale.
   a. Periods

The periods over which the performance is calculated for the strategy's buy and sell signals correspond to the time-scale of the signals. The histories of buy and sell signals for the period will contain a number of data points that is statistically meaningful according to the confidence interval for results that is required. For example, choosing a sample size of 120 data points would measure performances over periods of 24 weeks for daily signals, and more than two years for weekly signals.

b. Trading Costs

Performance statistics for the strategy are adjusted for trading costs per signal. Average trading costs across markets, or average trading costs within markets are used to reflect trading costs in performance results for the strategy. For example, a cost of 1% per buy and sell signal can be used.

c. Benchmarks

In order to obtain a comparative measure for the outcome of having followed a strategy's buy and sell signals for a security, the present invention will compare the performance over the period from following the signals to a benchmark performance for the security over the period.

1) Absolute Benchmarks

i) Absolute Return Benchmark. In this case, the strategy's performance for the security is measured against a benchmark performance of 0% for the security. If the strategy generates a positive return over the period, it will show a positive performance compared to benchmark. If the strategy generates a negative return over the period it will show a negative performance compared to benchmark. Comparing the strategy's performance to this benchmark will tell the user whether the strategy made money in the security, whatever the performance of the security over the period.
ii) Buy and Hold Return Benchmark. In this case, the strategy's performance is measured against the return from holding the security throughout the period. If the strategy generates a higher return by trading the security during the period than was had by holding the security during the period, it will show a positive performance compared to benchmark. Otherwise the strategy will show a negative performance compared to benchmark. Comparing the strategy's performance to this benchmark will tell the user whether the strategy made a higher return by not purchasing or trading the security than by holding the security over the period.
   2) Relative Benchmarks
i) Market Return Benchmark. In this case, the strategy's performance for the security is measured against a market index return over the period. If the strategy generates a higher return by trading the security during the period than was had by holding the market index during the period, it will show a positive performance compared to benchmark. Otherwise the strategy will show a negative performance compared to benchmark. Comparing the strategy's performance to this benchmark will tell the user whether the strategy made a higher return by trading the security than by holding the market index over the period.
ii) Buy and Hold Relative Return Benchmark. In this case, the strategy's performance is measured against the security's return relative to the market index from holding the security throughout the period. If the strategy generates a higher return relative to the market index by trading the security during the period than was had by holding the security during the period, it will show a positive performance compared to benchmark. Otherwise the strategy will show a negative performance compared to benchmark. Comparing the strategy's performance to this benchmark will tell the user whether the strategy made a higher return relative to the market by trading in and out of the security than by holding the security over the period.
a) The calculations for this benchmark are identical to those for the Buy and Hold Return benchmark except that the security's price history over the period is divided by the market index's price history over the period.
b) The market index can be any index—a global, regional or country index, a sector or industry index, a large capitalization or small capitalization index, etc.

Generally, the present invention provides a method for generating chart markup and automatically annotating a chart in the technical analysis of a timeseries.

Generally, the ASV technique determines the ASV inflection, or turning points, and categorizes them according to their bearing upon likely future price movements, while associating time, or lag, information with each identified point. First, the timeseries is defined, usually by taking some point of interest from a larger series (henceforth called the “end point”) and a suitable number of prior values to define a search period. The lag of each point with respect to the end point is determined, i.e. the end point has lag=0.

Once the ASV inflection points have been identified and categorized, and the desired formations recognized from the ASV inflection point data, the quality of the recognized patterns can be rated. The volatility feature set includes ASV formation type, ASV inflection points defining the formation, dates associated with each ASV inflection point, and trade volumes. Further features, also part of the volatility feature set, can be calculated from this information, depending on the formation type. These calculated, or derived, values can include trend height, trend duration, threshold price, pattern height, symmetry, and statistical measures of formation quality, well known to those of skill in the art.

Once a pattern has been recognized and the volatility feature set stored, the chart markup and annotation method of the present invention can be applied. Generally, the timeseries, or a portion thereof containing the recognized ASV formation, is displayed as a graphical timeseries chart. The timeseries can be displayed as an OHLC, candlestick or bar chart, as desired. Since the ASV inflection point data set contains time data, the ASV inflection points can be easily identified and marked on the displayed timeseries. Lines are then drawn between the ASV inflection points to graphically display the recognized pattern, and the ASV inflection points are labeled with the relevant spatial and/or time data, typically with their associated price and/or date.

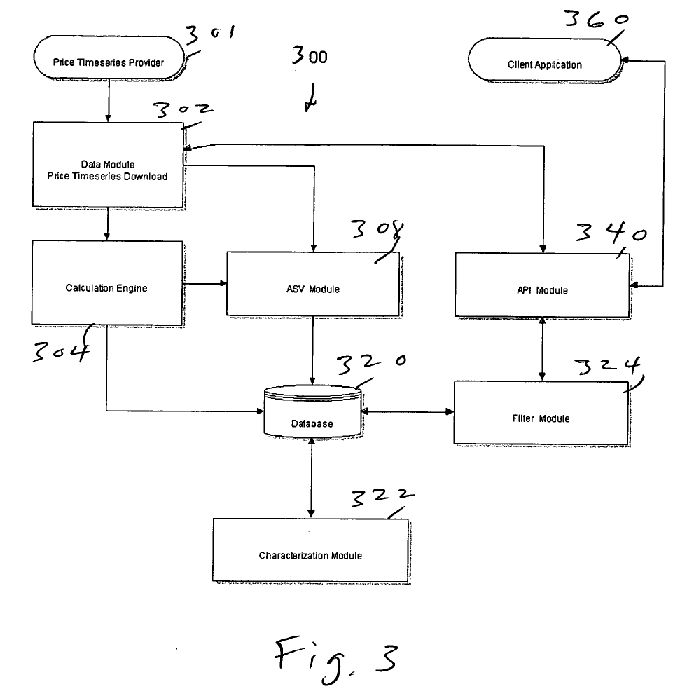

FIG. 3 is a block diagram of a system 300, according to an embodiment of the present invention. System 300 includes a number of interconnected modules, typically embodied as software modules. Market data module 302 provides market data, for example, daily stock market information such as high price, low price, open price, close price, volume, open interest and tick data values for stocks. The market data can be downloaded on a continuous, real-time basis directly from stock market providers 301, or can be sampled on a periodic basis, such as inter-day, daily or weekly. The market data can include data for a whole market, or data related to certain identified stocks. Market data module 302 feeds the market data to ASV module 308, which identifies candidate patterns at different window sizes. The identified candidate formations are written into a database 320 for further analysis. The ASV module 308 can also generate chart markup and annotation. The ASV module 308 also feeds the characterization module 322.

The calculation engine 304 computes, from the timeseries data, values, such as simple log-ratios of serial price values, and writes the calculated values into the database 320. These are technical analysis calculations that are used to initialize the ASV module 308.

Candidate patterns recognized by the ASV module 308 can also be ranked by human experts as a periodic training activity. In this case, candidate patterns are shown to human experts who then rank or rate this information based on their experience and back-test the results against historical performance of selected stocks and fundamental events in the companies' histories.

The characterization engine 322 computes various characteristics for every candidate pattern found by the ASV module 308. The characterization engine 322 reads candidate patterns, computes ASV pattern and event characteristics and write results back to database 320.

Patterns and event information, and characteristics are passed to filter 324 that screens output based on defined criteria. A filter 324 is defined for each user of the system 300. Filters 324 restrict the patterns passed out of the system 300 to ensure that patterns delivered meet certain minimum thresholds. For example, a filter may specify that only patterns having LN DELSIG σᵥ exceeding a certain value are to be passed.

The final result of the ASV analysis is the technical event annotation related to the timeseries data, which is stored in the database and signaled to the user via an API module 340 and a client application 360. The Markov Chain Monte Carlo tables are generated by standard Bayes Gibbs Sampler methods, and in the preferred embodiment are so calculated using WinBUGS™ software.

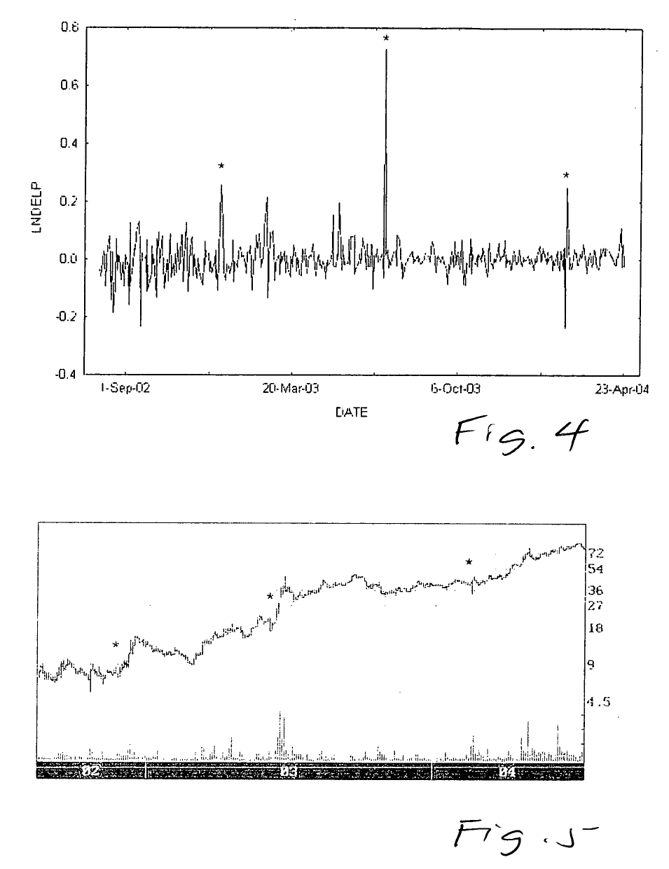

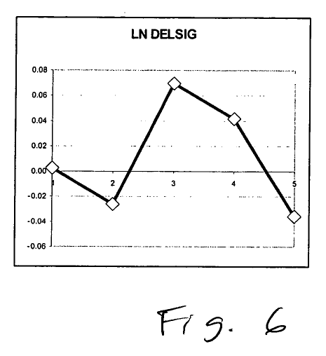

FIG. 4 shows a timeseries chart annotated according to the embodiment disclosed above. FIG. 5 shows a timeseries chart annotated according to a sample XML markup annotation.

In the preferred embodiment it is sufficient to use a burn-in period of 10,000 iterations to allow mixing and stabilization of the sampling, discard the burn-in sampled values of the parameters, reset the parameters' counters, then perform a follow-up of 50,000 iterations. In one embodiment, we initialize the Win BUGS MCMC Gibbs sampler by setting μ=0, φ=0.98, σᵥ²=0.025, and ρ=−0.40. This appears to work well, both for equities and portfolios that have large daily volume and large leverage correlation (ρ<−0.5) as well as for equities that have small leverage effect or a paradoxical inverse-leverage effect (ρ>0).

Each burn-in runs in approximately 10 min on a 1 GHz Pentium-III WinXP machine. For Xₜ timeseries that are 300 to 500 long, each 50,000 iteration sampling requires approximately 50 min elapsed wall-clock time.

It is important to check convergence to ensure that the sample is drawn from a stationary distribution. Therefore, results are preferably based on samples of not less than 10,000 iterations and are more preferably based on 50,000-iteration samples, each of which passed Heidelberger, Welch, and Gelman-Rubin convergence tests for all parameters.

Validation of the method was performed comparing two asymmetric SV models with Bayes factors. Specifically, the method of the present invention calculates the Bayes factors using the marginal likelihood approach of Chib (2002). The proposed ASV is as shown in Eq. (7) and Jacquier's ASV is as Eq. (8):

$$\begin{matrix}\{ \begin{matrix}{X}_{t} = {σ}_{t} {u}_{t} , \\ ln {σ}_{t + 1}^{2} = α + {ϕlnσ}_{t}^{2} + {ρσ}_{υ} , {σ}_{t}^{- 1} {X}_{t} + {σ}_{υ} \sqrt{1 - {ρ}^{2}} {w}_{t + 1} ,\end{matrix} \\ and & Eq .7 \\ \{ \begin{matrix}{X}_{t} = {σ}_{t} ( \sqrt{1 - {ρ}^{2}} {∈}_{t} + \frac{ρ}{{σ}_{υ}} ( ln {σ}_{t}^{2} - α - {ϕlnσ}_{t - 1}^{2} ) ) , \\ ln {σ}_{t}^{2} = α + {ϕlnσ}_{t - 1}^{2} + {σ}_{υ} , {v}_{t} ,\end{matrix} \\ where {w}_{t + 1} = ( {v}_{t + 1} - {pu}_{t} ) / \sqrt{1 - {ρ}^{2}} and {∈}_{t} = ( {u}_{t} - {pv}_{t} ) \sqrt{1 - {ρ}^{2}} . & Eq .8\end{matrix}$$

For back-testing various example stocks, a series of sentinel dates was selected for each, straddling relevant moments when decisions affecting the security were publicly released (e.g., IMCL, re: FDA's approval of erbitux on 12Feb. 2004; see Table I below and FIG. 6). Then historical end-of-day prices were downloaded and pre-processed for use with WinBUGS. The pattern of σᵥ was examined, to ascertain whether σᵥ (or other variables derived from it) could serve as a signal of the shift in share price that was consequent upon the decision or news.

Generally, the evolution of σᵥ is relatively slow, with shifts in investor sentiment manifesting themselves over periods of 10 or more trading days, more than sufficient time for the trader to undertake buy or sell trades to achieve the desired position in the security.

TABLE I

| DATE | MONTH | SIGMAV | RHO | −SIG/RHO | LNDELSIG | PRICE |
|---|---|---|---|---|---|---|
| 12-Dec-03 | 1 | 0.6058 | −0.2423 | 2.500 | 0.002 | $40.45 |
| 12-Jan-04 | 2 | 0.5903 | −0.2570 | 2.297 | −0.026 | $40.90 |
| 12-Feb-04 | 3 | 0.6327 | −0.2242 | 2.822 | 0.069 | $34.00 |
| 12-Mar-04 | 4 | 0.6596 | −0.2272 | 2.903 | 0.042 | $46.51 |
| 23-Apr-04 | 5 | 0.6364 | −0.2530 | 2.515 | −0.036 | $70.30 |

WinBUGS code implementing the ASV model of the present invention in Eq. (7) is:

model
{

mu ˜ dnorm(0,0.04)
phistar ˜ dbeta(20,1.5)
itau2 ˜ dgamma(2.5,0.025)
rho ˜ dunif(−1,1)

#beta <− exp(mu/2)

phi <− 2*phistar − 1
pi <− 3.141592654
sigmav <− sqrt(1/itau2)
theta0 ˜ dnorm(mu,itau2)
thmean[1] <− mu + phi*(theta0 − mu)
theta[1] ˜ dnorm(thmean[1],itau2)I(−100,100)

for (i in 2:N) {

thmean[i] <− mu + phi*(theta[i−1] − mu)
theta[i] ˜ dnorm(thmean[i],itau2)I(−80,80)
}

for(i in 1:(N−1)) {

Xmean[i] <− rho/sigmav*exp(0.5*theta[i])*

(theta[i+1] − mu − phi*(theta[i] − mu))

Xisigma2[i] <− 1/(exp(theta[i])*(1 − rho*rho))
X[i] ˜ dnorm(Xmean[i],Xisigma2[i])
loglike[i] <− (−0.5*log(2*pi) +

0.5*log(Xisigma2[i]) − 0.5*Xisigma2[i]*X[i]*X[i])

}

#Xmean[N] <− mu − phi*(theta[N] − mu)

Xmean[N] <− 0
Xisigma2[N] <− 1/(exp(theta[N]))
X[N] ˜ dnorm(Xmean[N],Xisigma2[N])
loglike[N] <− (−0.5*log(2*pi) + 0.5*log(Xisigma2[N])

0.5*Xisigma2[N]*X[N]*X[N])

node1 <− −sum(loglike[])

}
#data

...

#inits

...

The method takes the historical end-of-day price timeseries P(t) for the selected security, transforms this series to the logarithmic asset price s(t)=ln(P(t)), and calculates Xₜ=s(t+1)−s(t), which is equivalent to pairwise daily returns: ln(P(t+1)/P(t)). The parameters sigmav, rho, phi, and mu are monitored. The natural logs of the ratios of adjacent values of sigmav are calculated: ln(sigmav(t+1)/sigmav(t)). This normalized LNDELSIG value appears to be a robust leading indicator of an impending rally in small- and mid-cap equities characterized by thin trading in advance of general awareness of information that bears on the firm's long-term prospects. Values of LNDELSIG >0.05 consistently signal an impending rise in share price of 2× or more. Likewise, impending breakdowns (“gap-downs”) on negative news are also consistently signaled by LNDELSIG.

Understanding the finite-sample performance of Bayes MCMC estimators is important in several respects. First, it checks the reliability of the proposed Bayes MCMC estimators for the ASV model, in particular for the new leverage estimator, ρ. Second, since more estimation tools have recently been developed to estimate the discrete-time ASV models than continuous-time ASV models, it is interesting to compare directly the performance of Bayes MCMC estimates with other estimates in the discrete-time context. Sampling experiments were designed to examine the sampling properties of the proposed MCMC estimates for the new discrete-time ASV model, as applied to certain small- and mid-cap equities in the healthcare, pharma/biopharma, and biotech sectors, whose prospects and operating environment are subject to considerable uncertainty and speculation.

The Markov Chain Monte Carlo (MCMC) calculation functionality in the preferred embodiment is provided by BUGS™ or, more recently, WinBUGS™. However, any of a variety of Bayesian MCMC software applications are able to implement the Bayesian models discussed in earlier sections of the present invention.

While a preferred embodiment of the present invention and variations thereon have been set forth in detail above, those skilled in the art who have reviewed the present disclosure will readily appreciate that other embodiments can be realized within the present invention. For example, disclosures of specific computing and networking technologies are illustrative rather than limiting. Therefore, the present invention should be construed as limited only by the appended claims.

What is claimed is:

1. A method for generating markup for annotating a chart of timeseries data, wherein a volatility feature set of technical event data related to the timeseries data is stored in a database, the method comprising:
(a) receiving, from a client, a request for markup information related to an event;
(b) performing pattern recognition on the timeseries data based on an asymmetric stochastic volatility characterizing the timeseries data to characterize and classify features in the timeseries data;
(c) determining markup tags in accordance with the features which are characterized and classified in step (b);
(d) assembling the markup tags determined in step (c), in accordance with a markup format, to generate a markup annotation for the event, the markup annotation containing the markup information requested in step (a); and
(e) sending the markup annotation to the client.

2. The method of claim 1, further including, at the client, displaying the timeseries as a chart, and annotating the chart in accordance with the markup information.

3. The method of claim 2, further including analyzing and manipulating the markup information at the client.

4. The method of claim 1, wherein the request specifies a desired format for the markup information.

5. The method of claim 4, wherein the desired format is XML.

6. The method of claim 1, wherein the features are selected in accordance with the request.

7. An automated stock timeseries pattern search system comprising:
a computer;
a historical information database accessible by said computer, said historical information database having historical information for a plurality of investments stored thereon;
a connection to a supply of real-time data, said real-time data comprising real-time data relating to said plurality of investments;
chart-generating software executing on said computer for generating an investment chart for the stock or stocks to be examined based upon the historical information and the real-time data relating to the stock or stocks to be examined;
pattern-recognition software executing on said computer for performing pattern recognition on the historical information and the real-time data based on an asymmetric stochastic volatility characterizing the historical information and the real-time data to characterize and classify features in the historical information and the real-time data; and
markup software executing on said computer for retrieving asymmetric stochastic volatility markup annotations and for displaying the investment chart with annotations to determine if a pattern exists in the historical information and the real-time data.

8. The system of claim 7, further comprising pre-screening software executing on said computer for pre-screening the historical information and the real-time data relating to an investment to be examined to determine whether the investment to be examined meets a threshold value for liquidity, and wherein said pattern-recognition software executing on said computer performs the asymmetric stochastic volatility analysis if the investment to be examined meets the threshold value for liquidity.

9. The system of claim 8, wherein the investment to be examined is determined to meet the threshold value for the asymmetric stochastic volatility analysis.

10. The system of claim 8, further comprising software executing on said computer for examining a last point of the stock timeseries to determine whether the fundamental event is favorable or unfavorable, and whether the associated technical event in the share price will be a breakup or breakdown (“gap-up” or “gap-down”).
